(19) United States
(12) Patent Application Publication
(10) Pub. No.: US 2020/0327207 A1
(43) Pub. Date: Oct. 15, 2020

(54) Transient Sensitivity Analysis

(71) Applicant: ProPlus Electronics Co. Ltd., San Jose, CA (US)

(72) Inventors: Yutao MA, San Jose, CA (US); Zhenzhong Zhang, San Jose, CA (US)

(21) Appl. No.: 16/381,674

(22) Filed: Apr. 11, 2019

(51) Int. Cl. G06F 17/50

(52) U.S. Cl. CPC G06F 17/5036; G06F 17/5045

(57) ABSTRACT

The disclosure related to transient sensitivity analysis. A computer implemented method includes receiving a description of the circuit, performing a first pass transient simulation of the circuit using the time steps and the plurality of circuit parameters, includes determining time steps for performing sensitivity analysis of the circuit, recording circuit states at each time step for each node of the circuit based on the first pass transient simulation in a first database, where the circuit states includes a first set of circuit solutions, performing a second pass sensitivity simulation of the circuit using the time steps, variations of the plurality of circuit parameters and the first database, recording a second set of circuit solutions due to variations of the plurality of circuit parameters, and determining deviations of between the first set of circuit solutions and the second set of circuit solutions.

### FIELD

The present invention relates to the field of electronic design automation tools. In particular, the present invention relates to transient sensitivity analysis of an integrated circuit.

### BACKGROUND

An integrated circuit is a network of circuit elements such as resistors, capacitors, inductors, mutual inductors, transmission lines, diodes, bipolar junction transistors (BJT), junction field effect transistors (JFET), metal-oxide-semiconductor field effect transistors (MOSFET), metal-semiconductor field effect transistors (MESFET), thin-film transistors (TFT), etc.

The development of complicated integrated circuits often requires the use of powerful numerical simulation programs. For example, circuit simulation is an essential part in the design flow of integrated circuits, helping circuit designers to verify the functionality and performance of their designs without going through expensive fabrication processes. As the semiconductor processing technology migrates to nanometer dimensions, new simulation methodologies are needed to solve the new problems intrinsically existing in circuit design with nanometer features. Modern integrated circuits continually challenge circuit simulation algorithms and implementations in the development of new technology generations. The semiconductor industry requires EDA software with the ability to analyze nanometer effects like coupling noise, ground bounce, transmission line wave propagation, dynamic leakage current, supply voltage drop, and nonlinear device and circuit behavior, which are all related to dynamic current. Thus, detailed circuit simulation and transistor-level simulation have become one of the most effective ways to investigate and resolve issues with nanometer designs.

Examples of electronic circuit simulators include the Simulation Program with Integrated Circuit Emphasis (SPICE) developed at the University of California, Berkeley (UC Berkeley), and various enhanced versions or derivatives of SPICE. SPICE and its derivatives or enhanced versions will be referred to hereafter as SPICE circuit simulators, or SPICE. The SPICE method considers a circuit as a non-divided object.

SPICE-like simulations may provide fairly accurate predictions of how corresponding circuits will behave when actually built. The predictions are preferably made not only for individual sub-circuit but also for whole systems (e.g., whole integrated circuits) so that system-wide problems relating to noise and the like may be uncovered and dealt with. In a general process flow of a SPICE-like simulation, an analog integrated circuit under simulation is often represented in the form of a netlist description. A netlist is a circuit description of the analog circuit to be simulated written in a SPICE-like language. SPICE netlists are pure structural languages with simulation control statements. Other language like Verilog-A™ has the capability to include behavioral constructs. The structural netlist of SPICE together with a predefined set of circuit components of the analog integrated circuit may be represented in the form of a matrix in accordance with certain circuit modeling methodologies (which is not a concern of the present disclosure). The number of non-linear differential equations ranges from 1 to n. There are a corresponding number of input vectors to be operated by the linear equation. The set of input vectors are shown as {I₁, I₂, . . . Iₙ}. Next, the linear matrix is computed with the set of input vectors to generate a set of solution vectors {V₁, V₂, . . . Vₙ}. The computation is repeated until the set of solutions converge. The set of solutions may be then displayed in the form of waveforms, measurements, or checks on a computer screen for engineers to inspect the simulation results.

However, SPICE-like simulation of a whole system becomes more difficult and problematic as the industry continues its relentless trek of scaling down to smaller and smaller device geometries and of cramming more interconnected components into the system. An example of such down scaling is the recent shift from micron-sized channels toward deep submicron sized transistor channel lengths. Because of the smaller device geometries, a circuit designer are able to cram exponentially larger numbers of circuit components (e.g., transistors, diodes, capacitors) into a given integrated circuit (IC), and therefore increases the matrix size to a complexity which may not be solved in a desired time frame.

A circuit may be represented as a large numerically discrete nonlinear matrix for analyzing instant current. The matrix dimension is of the same order as the number of the nodes in the circuit. For transient analysis, this giant nonlinear system needs to solve hundreds of thousand times, thus restricting the capacity and performance of the SPICE method. The SPICE method in general can simulate a circuit up to about 50,000 nodes. Therefore it is not practical to use the SPICE method in full chip design. It is widely used in cell design, library building, and accuracy verification.

With some accuracy lost, the Fast SPICE method developed in the early 1990s provides capacity and speed about two orders of magnitude greater than the SPICE method. The performance gain was made by employing simplified models, circuit partition methods, and event-driven algorithms, and by taking advantage of circuit latency.

SPICE models a circuit in a node/element fashion, i.e., the circuit is regarded as a collection of various circuit elements connected at nodes. At the heart of SPICE is the so-called Nodal Analysis, which is accomplished by formulating nodal equations (or circuit equations) in matrix format to represent the circuit and by solving these nodal equations. The circuit elements are modeled by device models, which produce model results that are represented in the circuit equations as matrices.

A device model for modeling a circuit element, such as the SPICE model for modeling MOSFET devices, developed by UC Berkeley, typically includes model equations and a set of model parameters that mathematically represent characteristics of the circuit element under various bias conditions. For example, a circuit element with n terminals can be modeled by the following current-voltage relations:

Iᵢ=fᵢ(V₁, . . . ,Vₙ,t) for i=1, . . . ,n,

where Iᵢ represents the current entering terminal I; Vⱼ (j=1, . . . , n) represents the voltage or terminal bias across terminal j and a reference terminal, such as the ground; and t represents the time. The Kirchhoff's Current Law implies that the current entering terminal n is given by

$${I}_{n} = {\sum }_{i = 1}^{n - 1} {I}_{i} .$$

A conductance matrix of the circuit element is defined by:

$$G ( \begin{matrix}{V}_{1 ,} & … , & {V}_{n} , & t\end{matrix} ) := ( \begin{matrix}\frac{\partial {f}_{1}}{\partial {V}_{1}} & … & \frac{\partial {f}_{1}}{\partial {V}_{n}} \\ ⋮ & ⋱ & ⋮ \\ \frac{\partial {f}_{n}}{\partial {V}_{1}} & … & \frac{\partial {f}_{n}}{\partial {V}_{n}}\end{matrix} ) .$$

To model the circuit element under alternating current (AC) operations, the device model also considers the relationship between node charges and the terminal biases:

Qᵢ=qᵢ(V₁, . . . ,Vₙ,t) for i=1, . . . ,n.

where Qᵢ represents the node charge at terminal i. Thus, the capacitance matrix of the n-terminal circuit element is defined by

$$C ( \begin{matrix}{V}_{1 ,} & … , & {V}_{n} , & t\end{matrix} ) := ( \begin{matrix}\frac{\partial {q}_{1}}{\partial {V}_{1}} & … & \frac{\partial {q}_{1}}{\partial {V}_{n}} \\ ⋮ & ⋱ & ⋮ \\ \frac{\partial {q}_{n}}{\partial {V}_{1}} & … & \frac{\partial {q}_{n}}{\partial {V}_{n}}\end{matrix} ) .$$

For submicron design, there are more and more variation parameters. How to calculate those parameters' effect or sensitivity becomes more and more important. Designers need to know those variation parameters' sensitivity to optimize circuit behaviors.

In normal transient sensitivity analysis, the total simulation time increases linearly to increasing variation parameter numbers. As the number of variation parameters increase, for example from 100 to 10,000, normal transient sensitivity analysis becomes impractical as the total simulation time can be too long for a product development cycle.

Therefore, there is a need for methods and systems that address the issues of the conventional transient sensitivity analysis of an integrated circuit described above.

### SUMMARY

Method and system related to transient sensitivity analysis of an integrated circuit are disclosed. In one embodiment, a computer implemented method includes receiving a description of the circuit, where the description of the circuit includes a plurality of nodes interconnected with a plurality of circuit components, and further includes parameters of the plurality of circuit components, performing a first pass transient simulation of the circuit using the time steps and the plurality of circuit parameters, further includes determining time steps for performing sensitivity analysis of the circuit, based on the first pass transient simulation and variations of the parameters of the plurality of circuit components, recording circuit states at each time step for each node of the circuit based on the first pass transient simulation in a first database, where the circuit states includes a first set of circuit solutions, performing a second pass sensitivity simulation of the circuit using the time steps, variations of the plurality of circuit parameters and the first database, recording a second set of circuit solutions due to variations of the plurality of circuit parameters according to the second pass sensitivity simulation of the circuit, and determining deviations of between the first set of circuit solutions and the second set of circuit solutions.

In another embodiment, an apparatus configured to perform transient sensitivity analysis of an integrated circuit comprises one or more processors and a transient sensitivity analysis module controlled by the one or more processors; the transient sensitivity analysis module comprises logic configured to receive a description of the circuit that includes a plurality of nodes interconnected with a plurality of circuit components and further includes parameters of the plurality of circuit components, determine time steps for performing sensitivity analysis of the circuit with respect to variations of the parameters of the plurality of circuit components, perform a first pass transient simulation of the circuit using the time steps and the plurality of circuit parameters, record a first set of circuit solutions at each time step for each node of the circuit based on the first pass transient simulation in a first database, perform a second pass sensitivity simulation of the circuit using the time steps, variations of the plurality of circuit parameters and the first database, record a second set of circuit solutions of the second pass sensitivity simulation of the circuit according to the second pass sensitivity simulation of the circuit, and determine deviations of between the first set of circuit solutions and the second set of circuit solutions.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates a system for implementing methods of transient sensitivity analysis of an integrated circuit according to aspects of the present disclosure.

FIG. 2 illustrates an exemplary method of implementing transient sensitivity analysis of an integrated circuit according to aspects of the present disclosure.

FIG. 3A illustrates an exemplary implementation of performing a nominal transient simulation according to aspects of the present disclosure.

FIG. 3B illustrates another exemplary implementation of performing a nominal transient simulation according to aspects of the present disclosure.

FIG. 4A illustrates an exemplary forward method of performing transient sensitivity analysis according to aspects of the present disclosure.

FIG. 4B illustrates an exemplary method of solving for a circuit solution according to aspects of the present disclosure.

FIG. 4C illustrates another exemplary method of solving for a circuit solution according to aspects of the present disclosure.

FIG. 5A illustrates an exemplary backward method of performing transient sensitivity analysis according to aspects of the present disclosure.

FIG. 5B illustrates an exemplary method of solving for a circuit solution according to aspects of the present disclosure.

FIG. 5C illustrates another exemplary method of solving for a circuit solution according to aspects of the present disclosure.

FIG. 6 illustrates an exemplary architecture of a multiple core processor unit according to aspects of the present disclosure.

Like numbers are used throughout the figures.

### DESCRIPTION OF EMBODIMENTS

Methods and systems for transient sensitivity analysis of a circuit are provided. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

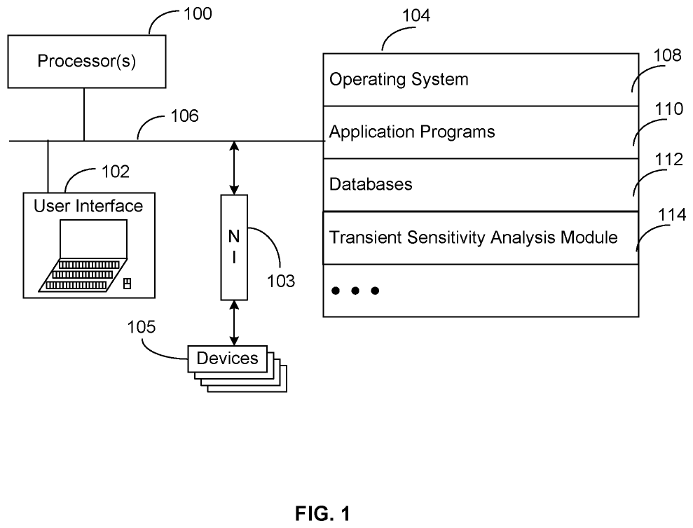

FIG. 1 illustrates a system for implementing methods of performing transient sensitivity analysis of a circuit according to an embodiment of the present disclosure. In one embodiment, the methods for performing transient sensitivity analysis of a circuit may be implemented using a computer system. The computer system may include one or more graphics processing units (GPUs) and/or central processing units (CPUs) 100 (hereinafter referred to as processor(s) for short), at least a user interface 102 for displaying computation results and waveforms, a memory device 104, a system bus 106, and one or more bus interfaces for connecting the GPUs/CPUs, user interface, memory device, and system bus together. The computer system also includes at least one network interface 103 for communicating with other devices 105 on a computer network. In alternative embodiments, certain functionalities of the method and system may be implemented in one or more application-specific integrated circuits (ASICs) or field-programmable gate arrays (FPGAs), thereby reducing the role of the GPU/CPU.

The memory device 104 may include high-speed random-access memory and may also include non-volatile memory, such as one or more magnetic disk storage devices. The memory device may also include mass storage that is located remotely from the GPUs/CPUs. The memory device preferably stores:
an operating system 108 that includes procedures for handling various basic system services and for performing hardware-dependent tasks;
application programs 110 for performing other user-defined applications and tasks, such as circuit simulations and device evaluations;
databases 112 for storing information of the integrated circuit, the databases include data structures, device models, and matrices;
transient sensitivity analysis module 114 configured to improve efficiencies of circuit simulations.

The databases, the application programs, and the program for implementing methods of performing transient sensitivity analysis of a circuit may include executable procedures, sub-modules, tables, and other data structures. In other embodiments, additional or different modules and data structures may be used, and some of the modules and/or data structures listed above may not be used.

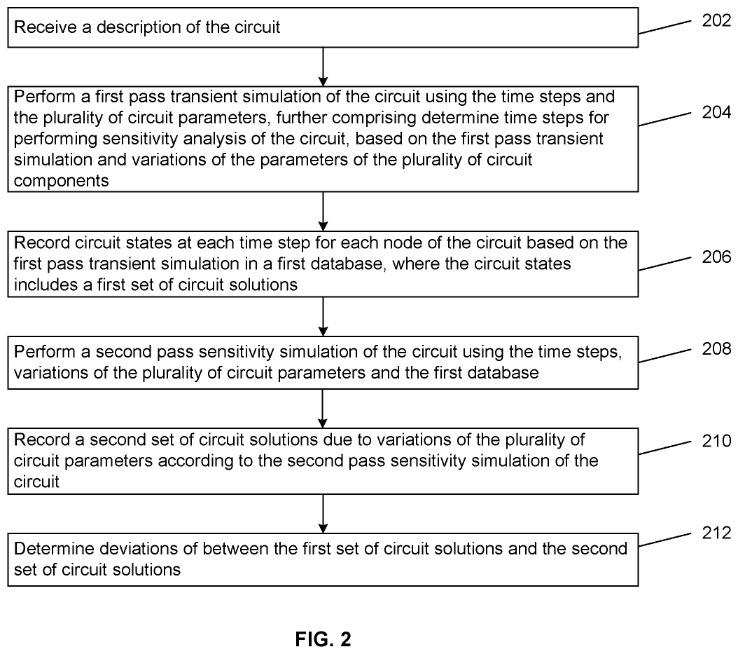

FIG. 2 illustrates an exemplary method of implementing transient sensitivity analysis of an integrated circuit according to aspects of the present disclosure. In the example shown in FIG. 2, in block 202, the method receives a description of the circuit, where the description of the circuit includes a plurality of nodes interconnected with a plurality of circuit components (also referred to as circuit devices or devices for short), and further includes parameters of the plurality of circuit components. In block 204, the method performs a first pass transient simulation of the circuit using the time steps and the plurality of circuit parameters, further comprising determining time steps for performing sensitivity analysis of the circuit, based on the first pass transient simulation and variations of the parameters of the plurality of circuit components. In block 206, the method records circuit states at each time step for each node of the circuit based on the first pass transient simulation in a first database, where the circuit states includes a first set of circuit solutions. In block 208, the method performs a second pass sensitivity simulation of the circuit using the time steps, variations of the plurality of circuit parameters and the first database. In block 210, the method records a second set of circuit solutions due to variations of the plurality of circuit parameters according to the second pass sensitivity simulation of the circuit. In block 212, the method determines deviations of between the first set of circuit solutions and the second set of circuit solutions.

According to aspects of the present disclosure, the variations of the parameters of the plurality of circuit components comprises at least one or more of: 1) variations due to deviations in manufacturing processes; 2) variations due to changes in circuit element geometry; 3) variations due to fluctuations in operating temperature of the circuit; or 4) variations due to fluctuations in operating voltage of the circuit. In some implementations, recording circuit states at each time step for each node of the circuit comprises at least one or more of: 1) storing solution vectors; 2) storing factored Jacobian matrices; or 3) storing circuit residues in form of currents and charges.

According to aspects of the present disclosure, since the time steps for performing sensitivity analysis of the circuit, based on the first pass transient simulation and variations of the parameters of the plurality of circuit components, the second pass sensitivity simulation of the circuit can take advantage of the time steps, variations of the plurality of circuit parameters and the circuit states determined in the first pass transient simulation of the circuit. One benefit of this approach is that in the second pass sensitivity simulation, the method can solve for circuit solutions due to variations of all circuit parameters at every time step, and reuse the resources created in the first pass transient simulation, such as the circuit states, Jacobian matrices at each time step and each node, and LU (lower and upper) factored Jacobian matrices. Thus, the disclosed approach is more efficient as it saves time as well as computation and storage resources.

According to aspects of the present disclosure, the circuit equation can be written as

$$\frac{d}{d t} q ( v , λ ) + i ( v , λ ) = u ( t ) \qquad ( 1 )$$

In this example, λ is a vector of variation parameter. Obtaining the circuit solution as function of λ may be implemented as a two-step process. First, a first pass transient simulation is performed to obtain the nominal case circuit solution, also referred to as the nominal transient simulation. The second step is to obtain the circuit solution v(t,λ) as a perturbation, also referred to as variations of circuit parameters, on the nominal case. Thus, let

$$λ = {λ}_{0} + Δλ , v ( t , λ ) = {v}_{0} ( t ) + Δ v ( t , λ ) and$$

$$Δ v ( t , λ ) = {\sum }_{k = 1}^{p} \frac{\partial v ( t )}{\partial {λ}_{k}} Δ {λ}_{k} .$$

Next, the current (i) and charge (q) function are expanded in Taylor series of Δλ, Δv. The equation for the first-order perturbation expansion can be obtained as follows.

$$\frac{d}{d t} [ \frac{\partial q}{\partial v} Δ v ] + \frac{\partial i}{\partial v} Δ v = - \frac{d}{d t} ( \frac{\partial q}{\partial λ} ) Δλ - \frac{\partial i}{\partial λ} Δλ \qquad ( 2 )$$

In some implementations, one way to compute circuit sensitivities from equation is to solve it once for each parameter one at a time as follows:

For each i:

$$\frac{d}{d t} [ \frac{\partial q}{\partial v} \frac{\partial v}{\partial {λ}_{i}} ] + \frac{\partial i}{\partial v} \frac{\partial v}{\partial {λ}_{k}} = - \frac{d}{d t} ( \frac{\partial q}{\partial {λ}_{i}} ) - \frac{\partial i}{\partial {λ}_{i}}$$

This gives the expression

$$v ( t , λ ) = {v}_{0} ( t ) + {\sum }_{k = 1}^{p} \frac{\partial v ( t )}{\partial {λ}_{i}} Δ {λ}_{i} .$$

Suppose the nominal system has been discretized into M time-point and operating point v₀(t) has been computed, introduce the capacitance and conductance matrix C, G as follows:

$${C}_{k} = \frac{\partial q}{\partial v} {\vert}_{v ( {t}_{k} )} {G}_{k} = \frac{\partial t}{\partial v} {\vert}_{v ( {t}_{k} )} ,$$

where k means kₜₕ time point.
Similarly, define the circuit residue function r as

$${r}_{k}^{q , l} = - {\frac{d}{d t} [ \frac{\partial q}{\partial {λ}_{1}} ]}_{v ( {t}_{k} )} , {r}_{k}^{i , t} = - {[ \frac{\partial i}{\partial {λ}_{l}} ]}_{v ( {t}_{l} )} and {r}_{k}^{l} = {r}_{k}^{q , l} + {r}_{k}^{i , t} .$$

In one approach, the Back-Euler method can be applied:

$$\frac{{C}_{1} {X}_{1}^{l} - {C}_{0} {X}_{0}^{l}}{{h}_{1}} + {G}_{1} {X}_{1} = {r}_{1}^{l} \\ \frac{{C}_{k} {X}_{k}^{l} - {C}_{k - 1} {X}_{k - 1}^{l}}{{h}_{k}} + {G}_{k} {X}_{k} = {r}_{k}^{l} \qquad ( 3 )$$

According to aspects of the present disclosure, there are similarities between the forward method and the first pass normal transient simulation, as it solves χ₁ . . . χₖ sequentially for each parameter l using above equation.

$$( \frac{{C}_{k}}{{h}_{k}} + {G}_{k} ) {X}_{k} = {r}_{k}^{l} + \frac{{C}_{k - 1} {X}_{k - 1}^{l}}{{h}_{k}} \qquad ( 4 )$$

According to aspects of the present disclosure, despite similarities between the backward method and the forward method, the backward method can be configured to solve the plurality of parameter variations in parallel. Mathematical deductions for backward method are shown below. Here, n is from 1 to M. The whole matrix is built.

$$C + G = \begin{matrix}\frac{{C}_{1}}{{h}_{1}} + {G}_{1} & ⋮ & \\ & - \frac{{C}_{k - 1}}{{h}_{k}} & \frac{{C}_{k}}{{h}_{k}} + {G}_{k}\end{matrix}$$

Define vector

$$X = [ \begin{matrix}{X}_{1}^{l} \\ ⋮ \\ {X}_{k}^{l}\end{matrix} ] , {r}^{l} = [ \begin{matrix}{r}_{1}^{l} \\ ⋮ \\ {r}_{k}^{l}\end{matrix} ] .$$

The vector r^{l} can be used to form the p columns (one columns for each parameter) of the matrix s. s=[r¹ . . . r^{p}].

To calculate the sensitivity of the circuit for parameter λₗ, the following equation is solved:

(C+G)χ=seₗ (5)

where eᵢ denotes the lth unit vector (Note that this vector has zero in all entries except entry l, where it is set to unity).

To calculate the sensitivity at time point j and node q, the vector E is constructed as follows:

$$E = \begin{matrix}{E}_{1} \\ ⋮ \\ {E}_{M}\end{matrix}$$

With the vector Eᵢ given by Eᵢ=eₖ, i=j Eᵢ=0, i≠j. Then the calculated sensitivity is aₖ^{l}=E^{T}χ^{l} at specific time point j and node q. Rewrite matrix format aₖ^{l}=E^{T}(C+G)⁻¹seₗ=((C+G)^{-T}E)^{T} seₗ using (5).

Then, solve equation

(C+G)^{T}u=E (6)

to obtain u.

Denoting the vector of sensitivities η=[aₖ¹ . . . aₖ^{l}] for all parameter:

η=u^{T}s (7)

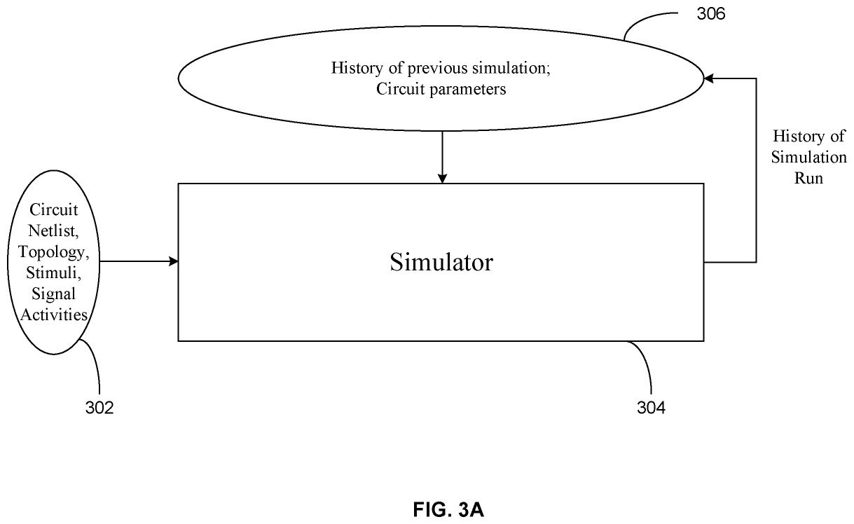

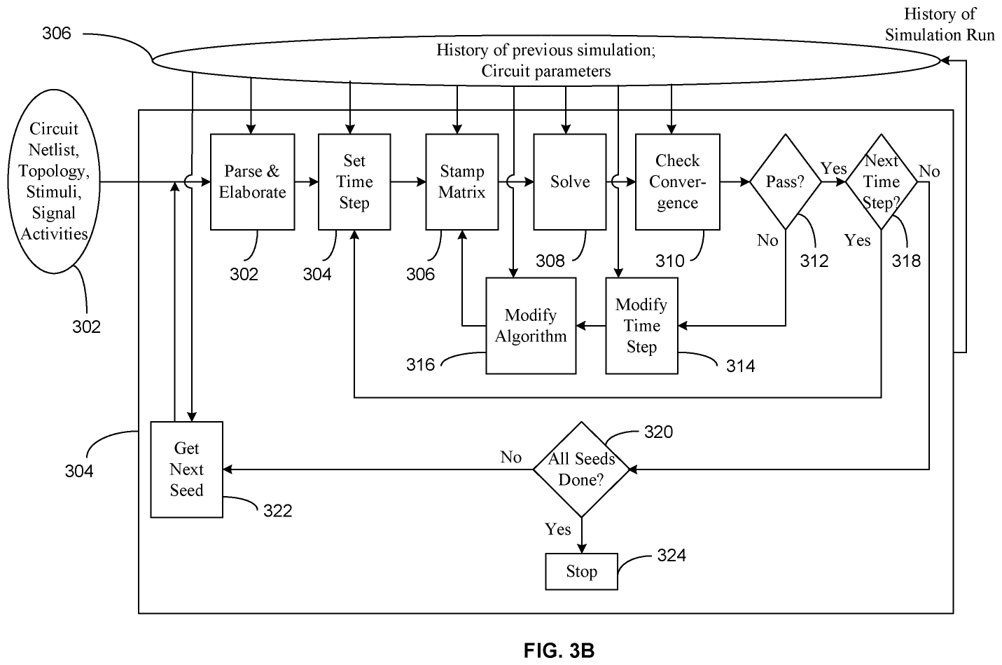

FIG. 3A illustrates an exemplary implementation of performing a nominal transient simulation according to aspects of the present disclosure. In the example shown in FIG. 3A, inputs 302 to a circuit simulator 304 include circuit netlist, which consists of descriptions of connectivity, instances and topologies of the circuit under simulation. The inputs 302 also include stimuli to the circuit as well as characteristics of signal activities. Additional inputs 306 to the simulator 304 includes histories of previous simulation, circuit parameters, and/or variations of circuit parameters. A history of a previous simulation may be captured by the simulator 304 and used for the subsequent simulations. Note that there are two types of statistical parameters. One type is the model parameter such as threshold voltage of a transistor model, etc. The second type is instant parameter such as channel width and length, temperature, supply voltage, etc. For simplicity, these two types of parameters are commonly referred to as statistical parameters in this disclosure.

According to embodiments of the present disclosure, the history of a previous simulation 306 may be captured for a period of time, and the period of time can be a single time step, multiple time steps, or an entire simulation time window. For example, the method may simulation a first circuit partition for one time step; and the simulation of all other circuit partitions can learn from the history of simulating the first circuit partition on the fly. In this manner, the storage overhead of the simulation can be reduced, because the information required for simulating the subsequent circuit partitions can be reused as they may still be in the memory. It follows that the simulation history of multiple time steps or the entire simulation time window of a first circuit partition may be stored for reuse for simulating subsequent circuit partitions.

FIG. 3B illustrates another exemplary implementation of performing a nominal transient simulation according to aspects of the present disclosure. An exemplary simulation flow performed by the simulator 304 and key blocks of the simulator are shown in FIG. 3B. For example, some of the key blocks include parse and elaborate 312, set time step 314, stamp matrix 316, solve 318, check convergence 320. In block 322, a first determination is made as to whether the simulation is passed. If the simulation is not passed (322_No), the method moves to block 324 where the time step is modified; follow by block 326 where the algorithm may be modified. After block 326, blocks 316, 318, 320, and 322 are repeated. If the simulation is passed (322_Yes), the method moves to block 328 where a second determination is made as to whether there is a next time step. If there is a next time step (328_Yes), the method moves to block 314 to set time step, and repeats the blocks after 314. If there is no next time step (328_No), the method moves to block 330. At block 330, a third determination is made as to whether all simulation seeds are done. If there are more seeds to simulate (330_No), the method moves to block 332 to get next seed. After block 332, the method repeats the flow chart from block 312 to block 330. If all simulation seeds are done (330_Yes), the method ends in block 334.

Note that arrows in FIG. 3B indicate communications between the inputs and the key blocks of the simulator. In the following sections of the disclosure, applications of using history of previous simulation and variations of parameters with the key blocks of the simulator are further described.

According to embodiments of the present disclosure, the solver (represented by block 318) may be configured to take into account the nature of the circuit analyses. In typical multi-pass simulation of complex integrated circuits, only a limited number of circuit variables are changed while the topology and stimuli of the circuit remain substantially the same. In such cases, the circuit matrix structure do not change for each seed, as the circuit matrix structure is determined by the circuit topology and stimuli, and it is not affected by the variations of statistical parameters. Although the circuit matrix structure does not change, the values of certain matrix components may be affected by the variation of the statistical parameters. In conventional simulators, there are two major portions of time spent on circuit simulation. First, the circuit matrix is largely sparse, but the simulator still spends lots of time to restructure every part of the matrix. This process is referred to as stamping, which may cost as high as 70% of the solving time. According to embodiments of the present disclosure, after the first pass simulation of the circuit, information pertaining to which portions of the circuit matrix need to be modified and which portions of the circuit matrix remain the same is provided to the solver, thus, the solver can be simplified to perform partial stamping and solving, instead of full LU solve, which lead to significant improvement in simulation efficiency.

With this approach, only a small portion of the circuit is resolved while the rest of the circuit may remain intact. As a result, the caching of the simulation data by processors associated with computing portions of a circuit matrix can be more efficient, and parallel solving may be scalable to number of processors (CPUs/GPUs). In other words, the circuit simulator may be configured to better use multiple processors to conduct the simulation in parallel in order to gain efficiency.

There are a number of ways to utilize the parallelism and task mapping capabilities of the processor. For small matrices, one way is to directly load the whole matrix into the processor, and split the job inside processor for parallel processing. Another way is to split the matrix into block matrices, which can be processed in parallel. And then move those block matrices into processor, do the solving in parallel. In this section, one method of split matrix into block matrices is given as an example.

For large matrices, to improve the level of parallel processing, a large matrix may be split into many smaller matrices (also referred to as block matrices). Then the smaller matrices are loaded in the processor, and the smaller matrices are solved in parallel. After the smaller matrices have been solved, the results are combined and stored as the results for the large matrix. With this approach, one way to achieve parallel processing is to assign a block of threads to handle one smaller matrix to be executed in a multiprocessor. Furthermore, within one block of threads, the smaller matrix may be solved in parallel using data structures and methods described in the following sections. According to embodiments of the present disclosure, a large matrix may be split into smaller matrices using the method described below. First, by changing the ordering of the rows/columns, the large matrix may be expressed in a form shown in equation 1, and then equation 1 may be further converted to equation 2.

$$\begin{matrix} [ \begin{matrix}{A}_{1} & & & {B}_{1} \\ & {A}_{2} & & {B}_{2} \\ & & {A}_{3} & {B}_{3} \\ {C}_{1} & {C}_{2} & {C}_{3} & D\end{matrix} ] [ \begin{matrix}{x}_{1} \\ {x}_{2} \\ {x}_{3} \\ {x}_{D}\end{matrix} ] = [ \begin{matrix}{b}_{1} \\ {b}_{2} \\ {b}_{3} \\ {b}_{D}\end{matrix} ] & ( eq . 1 ) \\ [ \begin{matrix}{A}_{1} & & & {B}_{1} \\ & {A}_{2} & & {B}_{2} \\ & & {A}_{3} & {B}_{3} \\ 0 & 0 & 0 & D - {\sum }_{i = 1}^{3} {C}_{i} {A}_{i}^{- 1} {B}_{i}\end{matrix} ] [ \begin{matrix}{x}_{1} \\ {x}_{2} \\ {x}_{3} \\ {x}_{D}\end{matrix} ] = [ \begin{matrix}{b}_{1} \\ {b}_{2} \\ {b}_{3} \\ {b}_{D} - {\sum }_{i = 1}^{3} {C}_{i} {A}_{i}^{- 1} {b}_{i}\end{matrix} ] & ( eq . 2 )\end{matrix}$$

From equation 2, the block matrices can be solved in a bottom-up manner on a block-by-block basis. In this example, the scheme may split the large matrix into 3 smaller matrices, namely A1, A2 and A3. And the processing of these smaller matrices may be done in parallel.

By applying the same technique, each smaller matrix (block matrix) may be split it into another group of block matrices. As a result, a hierarchical arrangement of multiple levels of block matrices may be formed. For example, a root block matrix represents the large matrix. At each level, a block may represent a block matrix derived from the root block matrix. Through this arrangement, since the block matrices at each level are independent of one another, they may be solved in parallel using the processor and its associated processors and blocks of threads.

In conventional simulators, one of the problems is that when a processor is assigned a task, after performing the task, it no longer retains information of that task, as it moves on to handle a new task, information about the previous task is lost. This is referred to as “data cache missing”, that is the states of the previous block of a circuit matrix are no longer available when the processor is solving the next block, because the conventional simulator has flushed the previous state out of its cache memory. As a result, the processor spends time in flushing its cache, and also spends time in setting up its cache memory for computing the next block. On the other hand, the approach of the present disclosure may be configured to use multiple processors for simulation because only a small portion of the circuit has been changed; majority of circuit may be cached in the memory during simulation. This can lead to orders of magnitudes of improvement in simulation efficiency. For example, if the solver is ten times faster and the parallelism is twenty times faster, the combined improvement is two hundred times faster because the two improvements are orthogonal to one another.

According to embodiments of the present disclosure, the disclosed time step control logic may reduce the total number of iterations per time step by using the history of previous simulations to guide the selection of time steps. As shown in FIG. 3B, the simulator loops to determine the best time step to use, sometimes it may even have to change algorithm in between iterations. Typically, the number of time steps is directly related the amount of time spent in simulation, for example, if the number of time steps can be reduced to half, the typically simulation time may also be reduced to half.

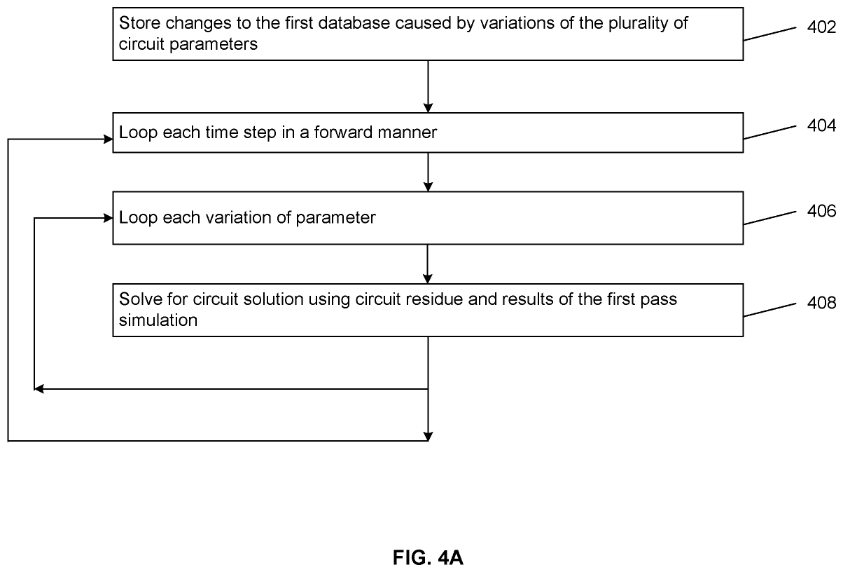

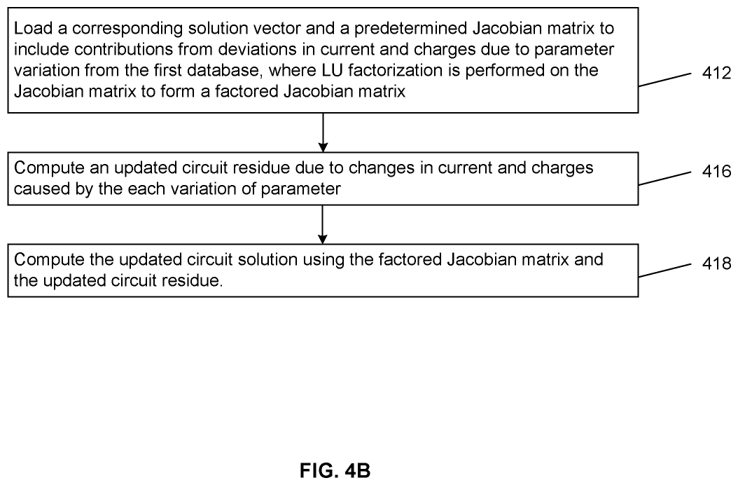

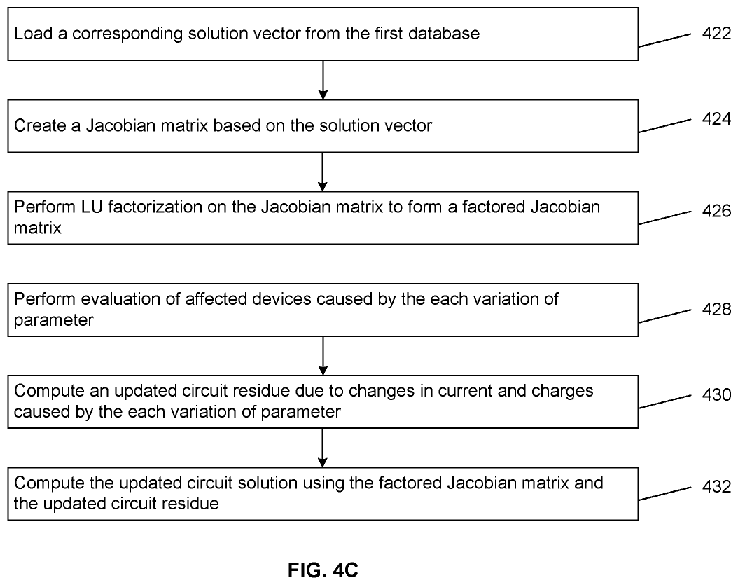

FIG. 4A illustrates an exemplary forward method of performing transient sensitivity analysis according to aspects of the present disclosure. In the example shown in FIG. 4, in block 402, the method stores changes to the first database caused by variations of the plurality of circuit parameters. In block 404, the method loops each time step from T₀ to T_{end} in a forward manner. In block 406, the method loops each variation of parameter. In block 408, the method solves for circuit solution using circuit residue and results of the first pass simulation as described in FIG. 3A and FIG. 3B.

FIG. 4B illustrates an exemplary method of solving for a circuit solution according to aspects of the present disclosure. In the exemplary method shown in FIG. 4B, in block 412, the method loads a corresponding solution vector and a factored Jacobian matrix from the first database, wherein LU factorization is performed on a predetermined Jacobian matrix from the first pass transient simulation to form the factored Jacobian matrix. In block 416, the method computes an updated circuit residue due to changes in current and charges caused by the each variation of parameter. In block 418, the method computes an updated circuit solution using the factored Jacobian matrix and the updated circuit residue.

FIG. 4C illustrates another exemplary method of solving for a circuit solution according to aspects of the present disclosure. As shown in FIG. 4C, in block 422, the method loads a corresponding solution vector from the first database. In block 424, the method creates a Jacobian matrix based on the solution vector. In block 426, the method performs LU factorization on the Jacobian matrix to form a factored Jacobian matrix. In block 428, the method performs evaluation of affected devices caused by the each variation of parameter. In block 430, the method computes an updated circuit residue due to changes in current and charges caused by the each variation of parameter. In block 432, the method computes an updated circuit solution using the factored Jacobian matrix and the updated circuit residue.

According to aspects of the present disclosure, the forward transient sensitivity analysis method may include the following steps:
Run normal transient analysis, store solution vectors and time point at each time point from T₀ to T_{end} in a first database, which may be implemented with memory mapped files.
For each parameter l from 1 to p, duplicated databases for the parameters are created, which allows for switching among the duplicated databases for different parameters.
For each parameter l from 1 to p,
For each time point from t_0 to t_n, in a forward manner:
1. Load the solution vectors of t_k from the file
2. Do device matrix evaluation and save nominal circuit residue into local matrix
3. Integrate Jacobian (G_k+C_k/h_k)
4. Factor the Jacobian matrix into L_kU_k=G_k+C_k/h_k
5. Obtain circuit residue_k=(deltaI_k+deltaQ_k/h_k)+kesai_(k−1)*C_(k−1)/h_k calculate kesai_k according to Lt_kUt_k*kesai_k=circuit residue_k for ith time point.

According to aspects of the present disclosure, one benefit of the forward method shown in FIG. 4A through FIG. 4C is that the second pass sensitivity simulation of the circuit can take advantage of the time steps, variations of the plurality of circuit parameters and the circuit states determined in the first pass transient simulation of the circuit. In other words, the forward method can solve for circuit solutions due to variations of all circuit parameters at every time step, and reuse the resources created in the first pass transient simulation, such as the circuit states, Jacobian matrices at each time step and each node, and LU (lower and upper) factored Jacobian matrices. Thus, the disclosed approach is more efficient as it saves time as well as computation and storage resources.

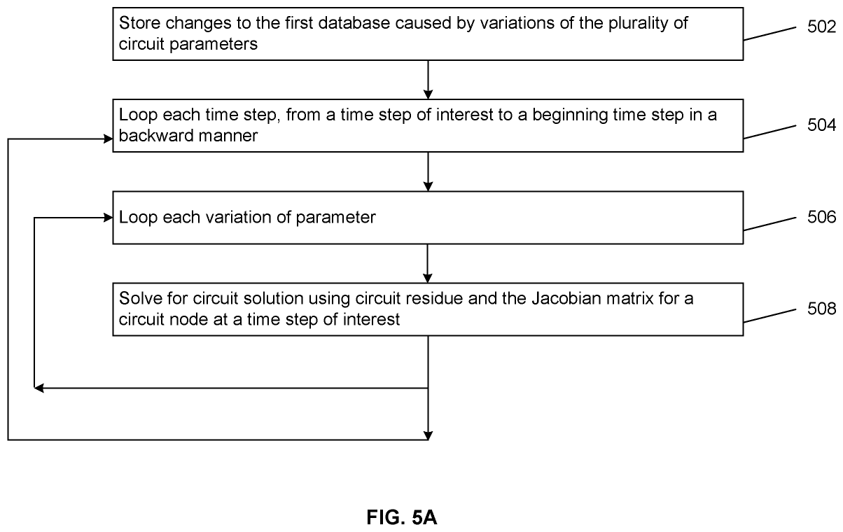

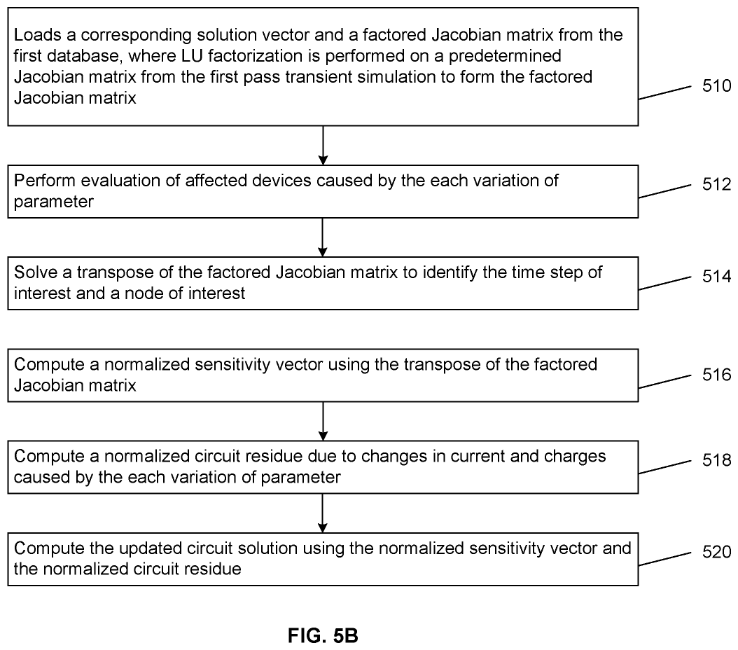

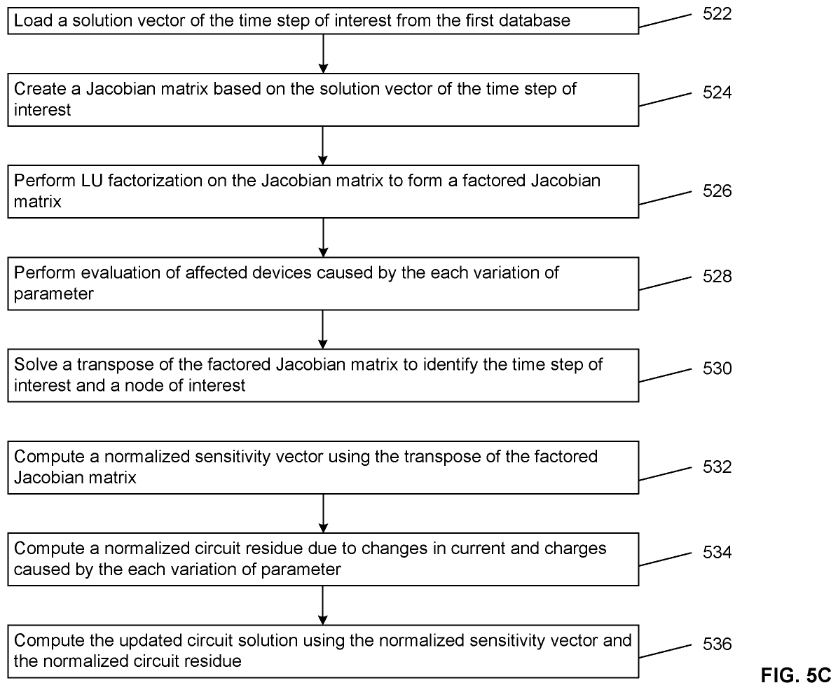

FIG. 5A illustrates an exemplary backward method of performing transient sensitivity analysis according to aspects of the present disclosure. In the example of FIG. 5A, in block 502, the method stores changes to the first database caused by variations of the plurality of circuit parameters. In block 504, from a time step of interest to a beginning time step in a backward manner, the method loops each time step. In block 506, the method loops through each variation of parameter in the plurality of parameters. In block 508, the method solves for an updated circuit solution in the second set of circuit solutions based on the each variation of parameter.

FIG. 5B illustrates an exemplary method of solving for a circuit solution according to aspects of the present disclosure. As shown in the exemplary method of FIG. 5B, in block 510, the method loads a corresponding solution vector and a factored Jacobian matrix from the first database, where LU factorization is performed on a predetermined Jacobian matrix from the first pass transient simulation to form the factored Jacobian matrix. In block 512, the method performs evaluation of affected devices caused by the each variation of parameter. In block 514, the method solves a transpose of the factored Jacobian matrix to identify the time step of interest and a node of interest. In block 516, the method computes a normalized sensitivity vector using the transpose of the factored Jacobian matrix. In block 518, the method computes a normalized circuit residue due to changes in current and charges caused by the each variation of parameter. In block 520, the method computes an updated circuit solution using the normalized sensitivity vector and the normalized circuit residue.

FIG. 5C illustrates another exemplary method of solving for a circuit solution according to aspects of the present disclosure. As shown in FIG. 5C, in block 522, the method loads a solution vector of the time step of interest from the first database. In block 524, the method creates a Jacobian matrix based on the solution vector of the time step of interest. In block 526, the method performs LU factorization on the Jacobian matrix to form a factored Jacobian matrix. In block 528, the method performs evaluation of affected devices caused by the each variation of parameter. In block 530, the method solves a transpose of the factored Jacobian matrix to identify the time step of interest and a node of interest. In block 532, the method computes a normalized sensitivity vector using the transpose of the factored Jacobian matrix. In block 534, the method computes a normalized circuit residue due to changes in current and charges caused by the each variation of parameter. In block 536, the method computes an updated circuit solution using the normalized sensitivity vector and the normalized circuit residue.

According to aspects of the present disclosure, the backward transient sensitivity analysis method may include the following steps:
Run normal transient analysis, store solution vectors and time point at each time point from T₀ to T_{end} in a memory mapped file.
For each parameter l from 1 to p, duplicated databases for the parameters are created, which allows for switching among the duplicated databases for different parameters.
For each time point from Tₙ to T₀, in a backward manner,
1. Load the solution vectors of time step Tₖ from the file;
2. Do device matrix evaluation and save nominal circuit residue into local matrix consider bypass;
3. Integrate Jacobian (G_k+C_k/h_k) using a backward approach;
4. Factor the transpose into Lt_kUt_k=G_k+C_k/h_k
5. According to measure results, obtain e and use circuit residue_k=e+u_(k+1)*C_k/h_(k−1). Then calculate u_k according to Lt_kUt_k*u_k=circuit residue_k for the kth time point.
6. For each parameter l from 1 to p:
   1) According item (2) saved data, switch to parameter l data.
   2) Do model equation and calculate delta_i and delta_q, and obtain yeta_k_1=u_k*(delta_i+dt(delta_q)).
   3) Accumulate yeta_k_1 for all time points to get total sensitivity.

According to aspects of the present disclosure, similar to the forward method, one benefit of the backward method shown in FIG. 5A through FIG. 5C is that the second pass sensitivity simulation of the circuit can take advantage of the time steps, variations of the plurality of circuit parameters and the circuit states determined in the first pass transient simulation of the circuit. In other words, the forward method can solve for circuit solutions due to variations of all circuit parameters at every time step, and reuse the resources created in the first pass transient simulation, such as the circuit states, Jacobian matrices at each time step and each node, and LU (lower and upper) factored Jacobian matrices. In addition, the backward method enables the computation of a circuit solution at a particular time point/step of interest and a part node of the circuit, which may be specified by a user. The backward method does not need to step through all the time steps, instead, the backward method may start from a time point of interest and loop the time steps in a backward manner. Thus, the disclosed approach is more efficient as it saves time as well as computation and storage resources.

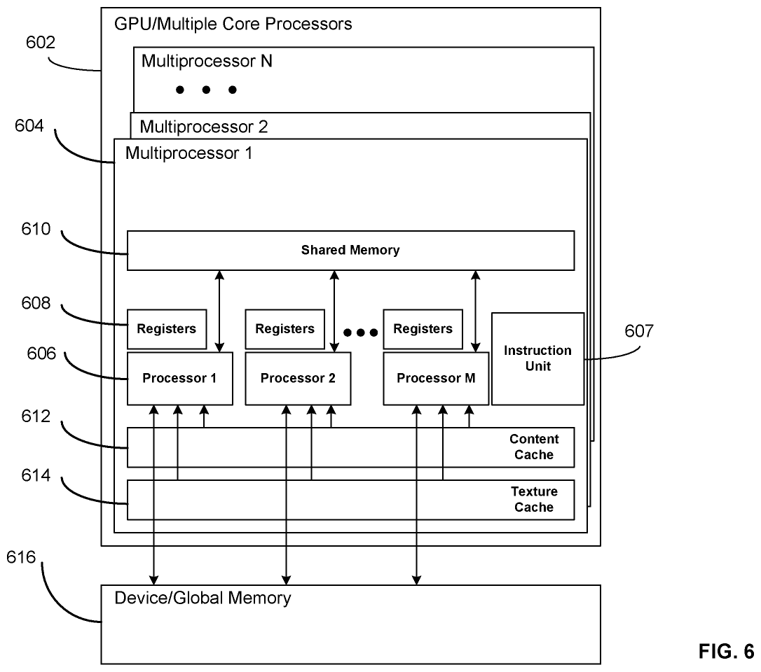

FIG. 6 illustrates an exemplary architecture of a multiple core processor (or graphics processor) unit according to some aspects of the present disclosure. As shown in FIG. 6, each GPU 602 includes N multiprocessors. Each multiprocessor 604 further includes M processors 606 and an instruction unit 607. Each processor has its own registers 608. All the processors 606 in one multiprocessor 604 share a block of shared memory 610. All the processors share the same set of constant cache 612 and texture cache 614 memories. They can also access the data in device memory 616, which is also referred to as the global memory.

In this example, each multiprocessor 604 has a block of shared memory. Accessing data from the shared memory 610 is much faster than accessing data from the device (global) memory 616. For this reason, one approach to increase computational efficiency is to load the data from the global memory 616 to the shared memory 610, perform much of the computations/manipulations using the shared memory 610, and then write back the results from the shared memory 610 to the global memory 616.

According to aspects of the present disclosure, improved transient mismatch calculation methods are disclosed. The disclosed methods can decrease sensitivity analysis time by orders of magnitude. There are two approaches of sensitivity analysis, one is referred to as the forward method, and the other is referred to as the backward method.

There are numerous advantages provided in the disclosed transient sensitivity analysis approaches. First, the performance improvements for the two methods can be shown with the following example. For example, the number of variation parameters is P. The average iteration number is defined as N-iteration per time step and the total time steps as N_T for the transient sensitivity analysis, and for all variation transient simulations, changes in those values may be negligible.

For per iteration, simulation time may include model evaluation time (M) and matrix solving time (S). Normal transient sensitivity analysis needs to finish P times transient simulation and it can take P*(M+S)*N_T*N-iteration. Alpha is defined as the ratio of the average effected device number of one parameter to the total device number.

With the above terminologies, the total simulation time of the forward method is approximately (M+S)*N_T*N-iteration+p*(M+S)*N_T+p*alpha*M*N_T. And the total simulation time of the backward method is approximately (M+S)*N_T*N-iteration+(M+S)*N_T+p*alpha*M*N_T.

In addition, LU factor results can be saved for every time step. This can decrease total simulation time further. In practice, the impact of most parameter variations are local. In other words, one parameter variation typically effects a few devices, and alpha is much less than 1. For backward method, it can reduce the total running time by few orders of magnitude when variation number is large, for example more than 1,000.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A computer implemented method of performing transient sensitivity analysis of a circuit, comprising:
receiving a description of the circuit, wherein the description of the circuit includes a plurality of nodes interconnected with a plurality of circuit components, and further includes parameters of the plurality of circuit components;
performing a first pass transient simulation of the circuit using the time steps and the plurality of circuit parameters, further comprising determining time steps for performing sensitivity analysis of the circuit, based on the first pass transient simulation and variations of the parameters of the plurality of circuit components;
recording circuit states at each time step for each node of the circuit based on the first pass transient simulation in a first database, wherein the circuit states includes a first set of circuit solutions;
performing a second pass sensitivity simulation of the circuit using the time steps, variations of the plurality of circuit parameters and the first database;
recording a second set of circuit solutions due to variations of the plurality of circuit parameters according to the second pass sensitivity simulation of the circuit; and
determining deviations of between the first set of circuit solutions and the second set of circuit solutions.

2. The computer implemented method of claim 1, wherein the variations of the parameters of the plurality of circuit components comprises at least one or more of:
variations due to deviations in manufacturing processes;
variations due to changes in circuit element geometry;
variations due to fluctuations in operating temperature of the circuit; or
variations due to fluctuations in operating voltage of the circuit.

3. The computer implemented method of claim 1, wherein performing a first pass transient simulation of the circuit comprises:
performing a nominal transient analysis on the parameters of the plurality of circuit components.

4. The computer implemented method of claim 1, wherein recording circuit states at each time step for each node of the circuit comprises at least one or more of:
storing solution vectors;
storing factored Jacobian matrices; or
storing circuit residues in form of currents and charges.

5. The computer implemented method of claim 1, wherein performing a second pass sensitivity simulation of the circuit comprises:
storing changes to the first database caused by variations of the plurality of circuit parameters;
for each time step in the plurality of time steps in a forward manner,
looping through each variation of parameter in the plurality of parameters; and
solving for an updated circuit solution in the second set of circuit solutions based on the each variation of parameter.

6. The computer implemented method of claim 5, wherein solving for an updated circuit solution comprises:
loading a corresponding solution vector and a factored Jacobian matrix from the first database, wherein LU factorization is performed on a predetermined Jacobian matrix from the first pass transient simulation to form the factored Jacobian matrix;
computing an updated circuit residue due to changes in current and charges caused by the each variation of parameter; and
computing the updated circuit solution using the factored Jacobian matrix and the updated circuit residue.

7. The computer implemented method of claim 5, wherein solving for an updated circuit solution further comprises:
loading a corresponding solution vector from the first database;
creating a Jacobian matrix based on the solution vector;
performing LU factorization on the Jacobian matrix to form a factored Jacobian matrix;
performing evaluation of affected devices caused by the each variation of parameter;
computing an updated circuit residue due to changes in current and charges caused by the each variation of parameter; and
computing the updated circuit solution using the factored Jacobian matrix and the updated circuit residue.

8. The computer implemented method of claim 1, wherein performing a second pass sensitivity simulation of the circuit further comprises:
storing changes to the first database caused by variations of the plurality of circuit parameters;
from a time step of interest to a beginning time step in a backward manner, looping each time step;
at each time step, looping through each variation of parameter in the plurality of parameters; and
solving for an updated circuit solution in the second set of circuit solutions based on the each variation of parameter.

9. The computer implemented method of claim 8, wherein solving for an updated circuit solution comprises:
loading a corresponding solution vector and a factored Jacobian matrix from the first database, wherein LU factorization is performed on a predetermined Jacobian matrix from the first pass transient simulation to form the factored Jacobian matrix;
performing evaluation of affected devices caused by the each variation of parameter;
solving a transpose of the factored Jacobian matrix to identify the time step of interest and a node of interest;
computing a normalized sensitivity vector using the transpose of the factored Jacobian matrix;
computing a normalized circuit residue due to changes in current and charges caused by the each variation of parameter; and
computing the updated circuit solution using the normalized sensitivity vector and the normalized circuit residue.

10. The computer implemented method of claim 8, wherein solving for an updated circuit solution further comprises:
loading a solution vector of the time step of interest from the first database;
creating a Jacobian matrix based on the solution vector of the time step of interest;
performing LU factorization on the Jacobian matrix to form a factored Jacobian matrix;
performing evaluation of affected devices caused by the each variation of parameter;
solving a transpose of the factored Jacobian matrix to identify the time step of interest and a node of interest;
computing a normalized sensitivity vector using the transpose of the factored Jacobian matrix;
computing a normalized circuit residue due to changes in current and charges caused by the each variation of parameter; and
computing the updated circuit solution using the normalized sensitivity vector and the normalized circuit residue.

11. An apparatus for performing transient sensitivity analysis of a circuit, comprising:
at least one processing unit for executing computer programs;
a memory for storing information of the circuit;
a transient sensitivity analysis module, wherein the transient sensitivity analysis module and the at least one processing unit includes logic configured to
receive a description of the circuit, wherein the description of the circuit includes a plurality of nodes interconnected with a plurality of circuit components, and further includes parameters of the plurality of circuit components;
perform a first pass transient simulation of the circuit using the time steps and the plurality of circuit parameters, further comprising determining time steps for performing sensitivity analysis of the circuit, based on the first pass transient simulation and variations of the parameters of the plurality of circuit components;
record circuit states at each time step for each node of the circuit based on the first pass transient simulation in a first database, wherein the circuit states includes a first set of circuit solutions;
perform a second pass sensitivity simulation of the circuit using the time steps, variations of the plurality of circuit parameters and the first database;
record a second set of circuit solutions due to variations of the plurality of circuit parameters according to the second pass sensitivity simulation of the circuit; and
determine deviations of between the first set of circuit solutions and the second set of circuit solutions.

12. The apparatus of claim 11, wherein the variations of the parameters of the plurality of circuit components comprises at least one or more of:
variations due to deviations in manufacturing processes;
variations due to changes in circuit element geometry;
variations due to fluctuations in operating temperature of the circuit; and
variations due to fluctuations in operating voltage of the circuit.

13. The apparatus of claim 11, wherein the transient sensitivity analysis module is further configured to:
perform a nominal transient analysis on the parameters of the plurality of circuit components.

14. The apparatus of claim 1, wherein the transient sensitivity analysis module is further configured to:
store solution vectors;
store factored Jacobian matrices; or
store circuit residues in form of currents and charges.

15. The apparatus of claim 11, wherein the transient sensitivity analysis module is further configured to:
store changes to the first database caused by variations of the plurality of circuit parameters;
for each time step in the plurality of time steps in a forward manner, loop each time step;
at each time step, loop through each variation of parameter in the plurality of parameters; and
solve for an updated circuit solution in the second set of circuit solutions based on the each variation of parameter.

16. The apparatus of claim 15, wherein the transient sensitivity analysis module is further configured to:
load a corresponding solution vector and a factored Jacobian matrix from the first database, wherein LU factorization is performed on a predetermined Jacobian matrix from the first pass transient simulation to form the factored Jacobian matrix;
compute an updated circuit residue due to changes in current and charges caused by the each variation of parameter; and
compute the updated circuit solution using the factored Jacobian matrix and the updated circuit residue.

17. The apparatus of claim 15, wherein the transient sensitivity analysis module is further configured to:
load a corresponding solution vector from the first database;
create a Jacobian matrix based on the solution vector;
perform LU factorization on the Jacobian matrix to form a factored Jacobian matrix;
perform evaluation of affected devices caused by the each variation of parameter;
compute an updated circuit residue due to changes in current and charges caused by the each variation of parameter; and
compute the updated circuit solution using the factored Jacobian matrix and the updated circuit residue.

18. The apparatus of claim 11, wherein the transient sensitivity analysis module is further configured to:
store changes to the first database caused by variations of the plurality of circuit parameters;
from a time step of interest to a beginning time step in a backward manner, loop each time step;
at each time step, loop through each variation of parameter in the plurality of parameters; and
solve for an updated circuit solution in the second set of circuit solutions based on the each variation of parameter.

19. The apparatus of claim 18, wherein the transient sensitivity analysis module is further configured to:
load a corresponding solution vector and a factored Jacobian matrix from the first database, wherein LU factorization is performed on a predetermined Jacobian matrix from the first pass transient simulation to form the factored Jacobian matrix;
perform evaluation of affected devices caused by the each variation of parameter;
solve a transpose of the factored Jacobian matrix to identify the time step of interest and a node of interest;
compute a normalized sensitivity vector using the transpose of the factored Jacobian matrix;
compute a normalized circuit residue due to changes in current and charges caused by the each variation of parameter; and
compute the updated circuit solution using the normalized sensitivity vector and the normalized circuit residue.

20. The apparatus of claim 18, wherein the transient sensitivity analysis module is further configured to:
load a solution vector of the time step of interest from the first database;
create a Jacobian matrix based on the solution vector of the time step of interest;
perform LU factorization on the Jacobian matrix to form a factored Jacobian matrix;
perform evaluation of affected devices caused by the each variation of parameter;
solve a transpose of the factored Jacobian matrix to identify the time step of interest and a node of interest;
compute a normalized sensitivity vector using the transpose of the factored Jacobian matrix;
compute a normalized circuit residue due to changes in current and charges caused by the each variation of parameter; and
compute the updated circuit solution using the normalized sensitivity vector and the normalized circuit residue.
